(19) United States
(12) Patent Application Publication
(10) Pub. No.: US 2026/0127333 A1
(43) Pub. Date: May 7, 2026

(54) INTELLIGENT DISMANTLING SYSTEM

(71) Applicant: INTERNATIONAL BUSINESS MACHINES CORPORATION, ARMONK, NY (US)

(72) Inventors: Jessica Nahulan, Vaughan (CA); Sarbajit Kumar Rakshit, Kolkata (IN); Carolina Garcia Delgado, Guadalajara (MX); Jennifer M Hatfield, Portland, OR (US)

(21) Appl. No.: 18/939,297

(22) Filed: Nov. 6, 2024

(51) Int. Cl. G06F 30/20; G06F 119/18

(52) U.S. Cl. CPC G06F 30/20; G06F 2119/18

(57) ABSTRACT

A method, computer system, and a computer program product for determining and implementing an ideal dismantling workflow is provided. The present invention may include generating a model of a structure to be dismantled. The present invention may include analyzing capabilities of a plurality of machines comprising a robotic system and a dismantling system. The present invention may include performing a plurality of simulations using the model of the structure to be dismantled and a plurality of digital twins corresponding to each machine within the robotic system and the dismantling system. The present invention may include generating an ideal dismantling workflow, wherein the ideal dismantling workflow includes at least a closed-loop three-dimensional (3D) contour and instructions for each machine within the robotic system and the dismantling system to be utilized in the dismantling of the structure.

### BACKGROUND

The present invention relates generally to the field of computing, and more particularly to intelligent workflow solutions.

Dismantling various structures of different sizes and materials requires precise planning and execution. These industrial dismantling processes must consider factors such as, but not limited to, structural stability, optimal cut paths, and reusability of cut portions, amongst various other considerations. Additionally, these industrial dismantling processes often lack a concise systematic approach which fail to consider advanced technologies and can lead to inefficiencies, challenges, and safety concerns.

### SUMMARY

Embodiments of the present invention disclose a method, computer system, and a computer program product for implementing an ideal dismantling workflow. The present invention may include generating a model of a structure to be dismantled. The present invention may include analyzing capabilities of a plurality of machines comprising a robotic system and a dismantling system, wherein the plurality of machines are designated by a user within a user interface for dismantling the structure. The present invention may include performing a plurality of simulations using the model of the structure to be dismantled and a plurality of digital twins corresponding to each machine within the robotic system and the dismantling system. The present invention may include generating an ideal dismantling workflow, wherein the ideal dismantling workflow includes at least a closed-loop three-dimensional (3D) contour and instructions for each machine within the robotic system and the dismantling system to be utilized in the dismantling of the structure.

In addition to a method, additional embodiments are directed to a computer system and a computer program product for generating an ideal dismantling workflow to dismantle a structure according to available robotic and dismantling systems based on a plurality of simulations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for determining an ideal dismantling workflow according to at least one embodiment.

### DETAILED DESCRIPTION

The following described exemplary embodiments provide a system, method and program product for determining an ideal dismantling workflow. As such, the present embodiment has the capacity to improve the technical field of intelligent workflow solutions by determining an ideal dismantling workflow for a structure based on a plurality of simulations performed using a model of the structure. More specifically, the present invention may include generating a model of a structure to be dismantled, analyzing capabilities of a plurality of machines comprising a robotic system and a dismantling system, performing a plurality of simulations using the model of the structure to be dismantled and a plurality of digital twins corresponding to each machine within the robotic system and the dismantling system, and generating an ideal dismantling workflow, wherein the ideal dismantling workflow includes at least a closed-loop three-dimensional (3D) contour and instructions for each machine within the robotic system and the dismantling system to be utilized in the dismantling of the structure.

As described previously, Dismantling various structures of different sizes and materials requires precise planning and execution. These industrial dismantling processes must consider factors such as, but not limited to, structural stability, optimal cut paths, and reusability of cut portions, amongst various other considerations. Additionally, these industrial dismantling processes often lack a concise systematic approach which fail to consider advanced technologies and can lead to inefficiencies, challenges, and safety concerns.

Therefore, it may be advantageous to, among other things, generate a model of a structure to be dismantled, analyze capabilities of a plurality of machines comprising a robotic system and a dismantling system, perform a plurality of simulations using the model of the structure to be dismantled and a plurality of digital twins corresponding to each machine within the robotic system and the dismantling system, and generate an ideal dismantling workflow, wherein the ideal dismantling workflow includes at least a closed-loop three-dimensional (3D) contour and instructions for each machine within the robotic system and the dismantling system to be utilized in the dismantling of the structure.

According to at least one embodiment, the present invention may improve the dismantling of structures by analyzing the capabilities of a plurality of machines comprising a robotic system and a dismantling system and designing an ideal dismantling workflow including instructions for each machine within the robotic system and dismantling system.

According to at least one embodiment, the present invention may improve the dismantling of structures, including, but not limited to including, bridge dismantling, industrial plant demolition, tall structure dismantling, oil and gas infrastructure removal, building demolition, and/or power plant dismantling by designing an automated and/or semi-automated workflow that includes a closed loop three-dimensional (3D) contour specific to the capabilities of a dismantling system utilizing a plasma cutting system.

According to at least one embodiment, the present invention may improve the safety of dismantling large and sometimes unstable structures by automating the process based on robotic system and dismantling system capabilities. Additionally, the safety of human operators within the dismantling workflow may be improved by the invention's ability to monitor the structural integrity of the structure being dismantled throughout the process by performing a plurality of real time simulations prior to and throughout the dismantling process. The invention further enables real time safety alerts based on these simulations.

According to at least one embodiment, the present invention may improve the ability of machine learning models to simulate dismantling processes by creating a baseline model based on initial simulation data and continuously refining, enhancing, and retraining the baseline model as additional data and additional simulations are performed. Furthermore, the invention not only utilizes a three-dimensional (3D) mesh model of the structure to be dismantled but a plurality digital twins corresponding to the robotic system and dismantling system which are updated in real time to reflect real world capabilities.

According to at least one embodiment, the present invention may improve industrial dismantling processes by creating a systematic approach for utilizing advanced technologies, such as, but not limited to, plasma cutting systems, that consider factors including structural stability, optimal cut paths, and reusability of cut portions.

According to at least one embodiment, the present invention may improve safety by considering the structural stability of the structure by performing structural integrity simulations that enable the invention to identify a proper sequence of cuts based on the current position of the center of gravity being integrated into the 3D model of the structure further enabling the invention to monitor a static equilibrium condition of the structure.

According to at least one embodiment, the present invention may improve reusability of materials by identifying portions of the structure suitable for re-use and prioritizing reusability use based on directed associated vendors or an internal need while determining optimal cutting methods and shape based on the defined capabilities of a dismantling system to maximize direct reusability of cut portions.

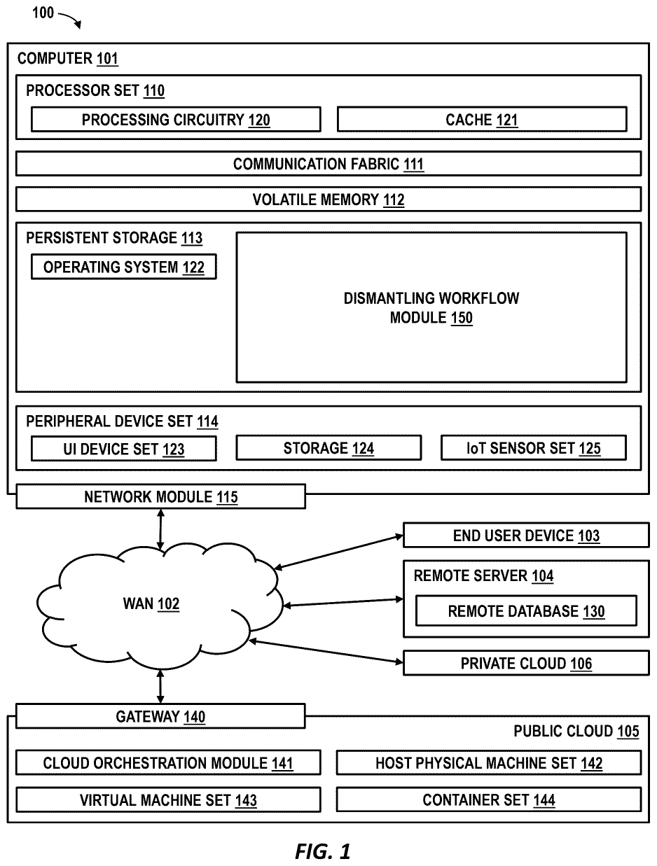

Referring to FIG. 1, Computing environment 100 contains an example of an environment for the execution of at least some of the computer code involved in performing the inventive methods, such as determining an ideal dismantling workflow for a structure based on a plurality of simulations performed using a model of the structure using the dismantling workflow module 150. In addition to module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

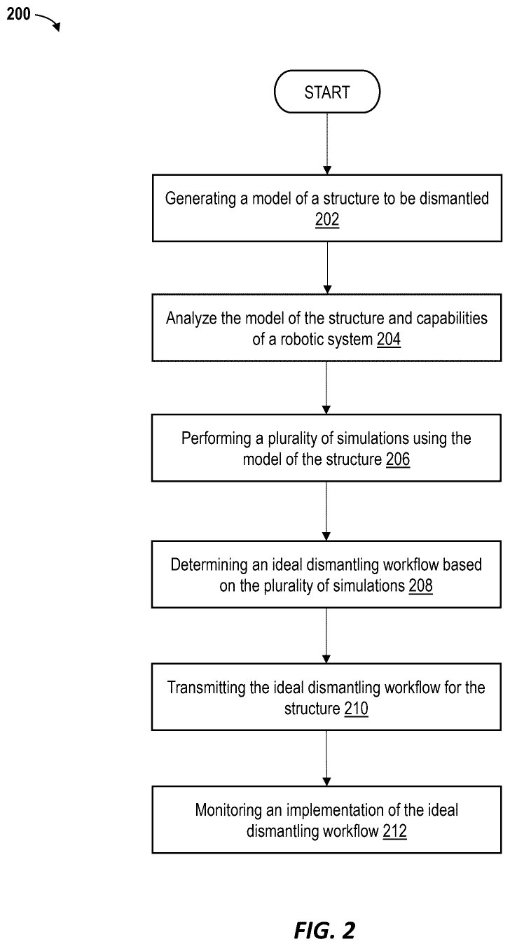

According to the present embodiment, the computer environment 100 may use the dismantling workflow module 150 to determine an ideal dismantling workflow for a structure based on a plurality of simulations performed using a model of the structure. The dismantling workflow method is explained in more detail below with respect to FIG. 2.

Referring now to FIG. 2, an operational flowchart illustrating the exemplary dismantling workflow process 200 used by the dismantling workflow module 150 according to at least one embodiment is depicted.

At 202, the dismantling workflow module 150 generates a model of a structure to be dismantled. The model may be a three-dimensional (3D) model. The dismantling workflow module 150 may generate the 3D model based on data received. Additionally, as will be explained in greater detail below at steps 204 and 206 the dismantling workflow module 150 may utilize the data received in generating a digital twin of the structure to be dismantled. The structure to be dismantled may be any object comprised of materials that the user wishes to repurpose, sell, recycle, or otherwise utilize.

The structure to be dismantled and the data received for the structure may be identified by the user of the dismantling workflow module 150 within a dismantling workflow user interface. The dismantling workflow module 150 may display the dismantling workflow user interface to the user in at least, an internet browser, dedicated software application, and/or as an integration with a third party software application. The dismantling workflow user interface may be part of the UI device set 123 and accessed by the user utilizing one or more of the EUDs 103. Additionally, the data received for the structure may be provided by the user directly within the dismantling workflow user interface and/or received one or more cameras, scanners, and/or one or more other Internet of Things (IoT) devices within the IoT sensor set 125 that may be associated with the structure to be dismantled. The data received from the user and/or from the one or more IoT devices may be stored in a knowledge corpus (e.g., database 130).

The data received for the structure from the user within the dismantling workflow user interface may include details such as, but not limited to, a brand, model number, bill of materials, product codes, part numbers, design specifications, production processes, engineering information, material composition of parts, amongst other data for the structure to be dismantled. In some embodiments, the dismantling workflow module 150 may also be capable of receiving a digital model of the structure directly from the user in one or more different file formats, including, but not limited to, Virtual Reality Modeling Language (VRML), OBJ file format, Polygon File Format (PLY), G-code format, amongst other formats. In embodiments, in which the structure to be dismantled is a 3D printed object the user may provide the dismantling workflow module 150 with additional information such as, but not limited to, stereolithography files (STL), Additive Manufacturing Files (AMF), printing instructions and/or records of materials utilized in the 3D printing process. The data received directly from one or more cameras, scanners, and/or one or more Internet of Things (IoT) devices associated with the structure to be dismantled may include, but not limited to, laser scans, LIDAR scans, 3D scans, photogrammetry information extracted from images or vides utilizing photogrammetry software, amongst other means of high-resolution data capture to ensure accuracy of the 3D model.

The dismantling workflow module 150 may utilize at least the data described above in generating a 3D model of the structure to be dismantled. The dismantling workflow module 150 may may generate the 3D model based on the data received utilizing one or more computer-aided design (CAD) packages. Once the 3D model of the structure to be dismantled is generated the dismantling workflow module 150 may convert the data received into a point cloud, representing the spatial distribution points in the structure. The dismantling workflow module 150 may then utilize the point cloud to generate a 3D mesh model of the structure and may apply one or more mesh generation algorithms in connecting a plurality of points comprising the point cloud into a surface representation. The one or more mesh generation algorithms may include, but are not limited to including a free meshing algorithm, the free meshing algorithm or other meshing algorithms utilized by the dismantling workflow module 150 may be general-purpose formulas which are adaptable for meshing conditions. For example, the surface representation of the 3D model structure may be comprised of interior holes or edges and as well as any number of sides. If, trios or quads are a selected element type, the dismantling workflow module 150 may further utilize one or more advancing front algorithms. If, mixed is the selected element type, the dismantling workflow module 150 may utilize one or more sub-mapping algorithms. The 3D mesh model and the algorithms utilized by the dismantling workflow module 150 will be described in further detail below in at least steps 204 and 206.

The dismantling workflow module 150 may also receive data with respect to at least a robotic system and/or dismantling system available to the user. The dismantling workflow module 150 may receive the data for the robotic system and/or dismantling system directly from the user in the dismantling workflow user interface and/or from one or more IoT devices associated with the robotic systems and/or dismantling systems.

The robotic system and/or the dismantling system may include a plurality of machines and/or other equipment which the user may have available for the dismantling process of the structure. As will be explained in more detail below, the robotic system and/or dismantling system may be comprised of both automated and non-automated machinery. The user may identify specific robotic systems such as, machines, trucks, cranes, and/or other industrial machinery within the dismantling workflow user interface which the user may designate for the dismantling of the structure. Accordingly, the dismantling workflow module 150 may receive data corresponding to the capabilities of both the robotic system and/or the dismantling system, such as, but not limited to, load bearing capacities, grip strength, Key Performance Indicator (KPI) data, maintenance/upkeep records, operating conditions, and overall health of the machine and/or machine components. For example, in at least one embodiment, the user may identify within the dismantling workflow user interface a truck to be utilized in transporting the materials of the structure to be dismantled, a forklift for loading the truck, and a plasma cutting system. In this example, the dismantling workflow module 150 may access the data available for each of these machines, including their specifications, capabilities, usage, model numbers, performance metrics, from the knowledge corpus (e.g., database 130). The dismantling workflow module 150 may then generate a digital twin for the truck, forklift, and plasma cutting system such that various simulations of the dismantling of the structure may be performed and a workflow designed for the dismantling of the structure.

The dismantling workflow module 150 may also receive specifications for the materials requested from the structure to be dismantled. The dismantling workflow module 150 may receive these specifications directly from the user and/or from a client request. For example, the user may input within the dismantling workflow user interface a request for 100 2-inch×4-inch pieces of steel to be recovered from the structure. The dismantling workflow module 150 may also be integrated with a client interface in which clients of the user may order specific materials and dimensions. For example, a client may place an order for 18 Gauge 60 foot copper wire, which the dismantling workflow module 150 may receive and identify within the structure to be dismantled. As will be explained in more detail below, the dismantling workflow module 150 may continuously receive orders from clients and/or requests from the user for materials from a structure and utilize these requests in generating an ideal dismantling workflow based on the simulations performed and described below. The dismantling workflow module 150 may be able to update the ideal dismantling workflow based on additional requests received during the dismantling process and may also consider the price of materials, order or request dates, and/or other structures in which the user identified for dismantling in generating the ideal dismantling workflow.

The dismantling workflow module 150 may also maintain a list of material requests within the knowledge corpus (e.g., database 130) such that the dismantling workflow module 150 may identify different combinations of material request that optimize the dismantling output for a given structure. In this example, the dismantling workflow module 150 may also maintain a list of additional structures to be dismantled which may be considered in the trial-and-error simulations. The user may rank the priority of order requests and/or specifications of materials to be derived from the dismantling process within the dismantling workflow user interface and/or set user preferences within the dismantling workflow user interface, such as, prioritizing particularly clients, prioritizing older or dated material requests, prioritizing material orders with a highest margin, prioritizing larger order, prioritizing material orders based on difficulty of storage and/or space occupied, amongst other considerations. The dismantling workflow module 150 may learn the preferences of the user over time and gradually automate the ranking of the list of material requests over time. The dismantling workflow module 150 may learn the preferences of the user based on the simulation outcomes selected by the user at step 206.

In some embodiments, the user may identify all robotic systems and/or dismantling systems the user has access to and the dismantling workflow module 150 may identify different combinations of the machines comprising the robotic systems and/or dismantling systems which may be ideal for the dismantling of the structure based on at least the desired sizes, shapes, and materials of a client request while considering one or more other workflows that may require simultaneous performance. In this embodiment, the user may identify or designate one of the one or more combinations recommended by the dismantling workflow module 150 in the dismantling workflow user interface. As will be explained in more detail below, the dismantling workflow module 150 may closely analyze the robotic systems, dismantling systems, and the structure to be dismantled such that the simulations performed, and ideal dismantling workflow generated correspond accurately to the physical environment.

At 204, the dismantling workflow module 150 analyzes the model of the structure and capabilities of the robotic system and dismantling system designated for the dismantling of the structure. The dismantling workflow module 150 may analyze and/or enhance the 3D mesh model of the structure utilizing the one or more techniques described below.

The dismantling workflow module 150 may enhance the 3D mesh model of the structure as described at step 202 utilizing one or more advancing front algorithms to traverse a perimeter of a region, placing elements along the edges as it proceeds, each site where an element may be placed is measured and one or more of a plurality of elements is selected. The dismantling workflow module 150 may continuously utilize the one or more advancing front algorithms such that an entire region is filled with elements. The dismantling workflow module 150 may then analyze the group of elements to determine whether a local change in connectivity may improve element quality. Additionally, the dismantling workflow module 150 may repeatedly apply one or more selected smoothing algorithms until none of the nodes of the 3D mesh model are moved further than a specified smoothing tolerance. Furthermore, as described above at step 202, the dismantling workflow module 150 may continuously enhance the 3D mesh model by implementing one or more granular mesh modeling techniques to divide the structure into smaller elements which may enable the 3D model to include fine details and intricate features.

The dismantling workflow module 150 may also further analyze the images, video, 3D scans, and/or other data received at step 202 for the structure to identify the material properties and specifications of the different regions of the 3D model. For example, the dismantling workflow module 150 may utilize the scans and images of the structure to identify different materials utilized for the structure in different regions of the 3D model. In this example, the dismantling workflow module 150 may leverage details provided by the user as well as a material database stored in the knowledge corpus (e.g., database 130) in addition to the images or scans in identifying the material properties and specifications of the different regions of the structure.

The dismantling workflow module 150 may utilize the material properties and specifications of the different regions for integrating weight distribution modeling into the 3D model. As will be explained in more detail at step 206, the integration of the weight distribution modeling into the 3D model may enable the dismantling workflow module 150 to identify optimum geometries of cut pieces as well as the instability which may result from the removal of cut pieces on the overall structure. The dismantling workflow module 150 may utilize a structural analysis to validate the weight distribution of the 3D model and also verify the model reflects the actual structural behavior under various conditions. Additionally, the dismantling workflow module 150 may analyze the structure to integrate a current position of a center of gravity into the 3D model including a static equilibrium condition of the structure. This may enable the dismantling workflow module 150 to perform load distribution simulations on different portions or regions of the 3D model. As will be explained in more detail below, the enhanced 3D model of the structure may enable the dismantling workflow module 150 to better recognize different portions of the 3D model and corresponding structure which may be used to fill client and/or user material requirements, recycled and/or repurposed, while maintaining the stability of the structure during the dismantling process.

The dismantling workflow module 150 may analyze the robotic systems and/or dismantling systems designated and/or selected by the user for dismantling the structure at step 202 based on the data received at step 202. For example, the dismantling workflow module 150 may utilize the data received at step 202 to determine capacities, gripping capabilities, carrying capabilities, payload capacity during movement, stability of the robotic systems when carrying various loads, acceleration, deceleration, and directional change capabilities, maximum geometric carrying capabilities, maximum payload lifting capacities, strength of robotic arms, joints, and/or other lifting mechanisms, amongst other capacities and capabilities. For example, during the evaluation of payload capacity the dismantling workflow module 150 may consider factors such as, but not limited to, torque, motor power, and structural integrity which may be derived from, for example, the KPI data, machinery specifications, and maintenance records received at step 202. In another example, the dismantling workflow module 150 may perform a Gripping Mechanism Assessment, to evaluate the gripping mechanism of one or more machines within the robotic system, including, but not limited to, types of grippers (i.e., robotic hands, claws, suction devices), gripping force, precision, and/or adaptability of the grippers to various shapes and sizes of objections from the robotic specification. As will be explained in more detail at steps 206 and 208, these capacities of the robotic systems and/or dismantling systems may be utilized as boundary conditions by the dismantling workflow module 150 in performing the plurality of simulations and determining the ideal dismantling workflow. This may enable the dismantling workflow module 150 to determine the ideal dismantling workflow which considers length, width, height, and any other specific geometrical features specified at step 202 and design a workflow within the capabilities of the robotic system according to historical data and corresponding specifications.

At 206, the dismantling workflow module 150 performs a plurality of simulations using the model of the structure. The dismantling workflow module 150 may perform the plurality of simulations using a digital twin derived from the 3D model of the structure and one or more digital twins corresponding to each of the machines of the robotic system and the dismantling system. A digital twin herein can refer to a virtual representation of a physical object, system or other asset.

The digital twin may track changes to the physical asset across the object's lifespan and records the changes as they occur. For example, a digital twin of a machine within the robotic systems may be continuously updated as additional data is received such that the digital twin reflects the current capabilities and capacities of the machine. Digital twins may define a complex virtual model that is a precise counterpart to the physical asset existing in real space. Sensors, IoT devices, and other means of collecting and/or receiving data as described in step 202 may continuously receive data, often in real-time, this data may then be mapped to the virtual model of the digital twin. Any individual with access to the dismantling workflow user interface may access the real-time information about the physical asset operating in the real works without having to be physically present. As will be described in more detail below, the user can utilize the digital twin to understand how the physical asset is performing, but also predict how the physical asset may perform over time. In this invention, the dismantling workflow module 150 may utilize the digital twins in at least, simulation, machine learning, and/or reasoning in aiding informed decision making, as will be explained in more detail below.

The dismantling workflow module 150 may perform a plurality of simulations using a plurality of digital twins. The plurality of digital twin may include, but are not limited to including, the structure digital twin, the robotic system digital twin, and the dismantling system digital twin.

The plurality of simulations performed by the dismantling workflow module 150 may include a series of trial-and-error simulations, the trial-and-error simulations may be visual simulations viewable by the user within the dismantling workflow user interface. The series of trial-and-error simulations may be performed according to various sets of parameters, such as, different combinations of the machines and/or equipment within the robotic system the user identified as available for dismantling of the structure at step 202, different combinations of the machines and/or equipment within the dismantling system the user identified as available, dismantling duration, the list of materials requests and corresponding specifications maintained in the knowledge corpus (e.g., database 130), amongst other parameters which may be modified or adjusted to evaluate different scenarios for dismantling the structure. The dismantling workflow module 150 may also consider the user preferences described at step 202 in the trial-and-error simulations, such as, but not limited to, priority of particular clients, priority of older or dated material requests, prioritizing higher margin materials, larger material orders, all orders with a particular destination to reduce shipment and/or transportation costs, amongst other factors. The trial-and-error simulations may further include the boundary conditions or limitations derived from the analysis of the robotic system performed at step 204, as well as the capabilities of the dismantling system.

For each of the plurality of trial-and-error simulations the dismantling workflow module 150 may store the corresponding simulation data in knowledge corpus (e.g., database 130). The dismantling workflow module 150 may then utilize one or more classification techniques, such as, but not limited to, a binary classification model and/or multi-class classification model to classify the simulation data associated with each of the plurality of trial-and-error simulations. For example, the dismantling workflow module 150 may classify a portion of the trial-and-error simulations as fully automated and the remaining portion as requiring human input or operation. The dismantling workflow module 150 may rank the plurality of trial-and-error simulations according to user preferences and/or various other metrics and display the ranking of each of the plurality of the trial-and-error simulations to the user within the dismantling workflow user interface. The dismantling workflow user interface may further enable the user to apply filters, such as, projected time, order requests fulfilled, percentage of structure utilized, amongst other filters within the dismantling workflow user interface and the dismantling workflow module 150 may re-rank and/or sort the results accordingly. The user may also be able to compare two or more selected workflows based on the simulations and swipe within the user interface to compare various metrics between the two or more selected workflows. The user may also retrieve all of the simulation data corresponding to each of the trial-and-error simulations and/or provide additional parameters for the simulation to consider. For example, if the user is not satisfied with the projected times of dismantling the user may identify additional machines within the robotic system and/or equipment within the dismantling system for the dismantling workflow module 150 to utilize in updating the simulation parameters and re-run the trial-and-error simulations. Additionally, for each of the trial-and-error simulations the user may access a corresponding explanation of the benefits and drawbacks to implementation generated by the dismantling workflow module 150 based on the simulation results. The dismantling workflow module 150 may utilize a machine learning model with utilizing various Natural Language Processing (NLP) techniques, such as those implemented in IBM Watson® (IBM Watson® and all Watson-based trademarks are trademarks or registered trademarks of International Business Machines Corporation in the United States, and/or other countries), IBM Watson® Natural Language Understanding, IBM Watson® Natural Language Processing, in generating the corresponding explanation based on the trial-and-error simulation results.

As will be explained in more detail below at step 208, the dismantling workflow module 150 may generate the ideal dismantling workflow from one of the plurality of workflows corresponding to the plurality of trial-and-error simulations based on the selection of the user within the dismantling workflow user interface. Over time, the dismantling workflow module 150 may automatically select the ideal dismantling workflow based on a generated ranking, the dismantling workflow module 150 may be enabled to automatically select and implement the ideal dismantling workflow by the user within the dismantling workflow user interface. Alternatively, the user may enable the dismantling workflow module to recommend one or more of the ideal dismantling workflows to the user and require user approval prior to implementation. The one or more ideal dismantling workflows recommended to the user may include an explanation corresponding to the recommendation generated using the NLP techniques described above.

The simulation data generated from the plurality of trial-and-error simulations may be further utilized in generating a baseline machine learning model (e.g., baseline model) which may be utilized in enhancing the strategic functions of the robotic system, creating a closed-loop 3D contour, and performing additional simulations. The additional simulations, may include, but are not limited to including, structural integrity simulations, kinetic simulations, and/or reusability simulations, all of which will be utilized in enhancing and refining the baseline model. The dismantling workflow module 150 may perform the structural integrity simulation using finite element analysis (FEA) to assess the structural integrity of the 3D model/digital twin of the structure throughout the dismantling process. Here, the dismantling workflow module 150 may divide the 3D model into a finite number of elements via meshing and apply relevant physics representations and/or equations to each element, then assemble the equations and solve them. The structural integrity analysis may continuously consider the removed portions of the structure during the simulations by calculating at least weight distribution changes and center of gravity shifts to predict structural responses based on the removal of various portions. In addition, the FEA analysis may be utilized by the dismantling workflow module 150 in further assessing the structural integrity following each cut by performing a stress analysis enabling the dismantling workflow module 150 to evaluate the impact of removed portions on the remaining structure. The dismantling workflow module 150 may perform the kinetic simulation for planning the movement of the one or more machines comprising the robotic system and/or the dismantling system. For example, the dismantling workflow module 150 may utilize the kinetic simulation for planning the movement of robotic arms and/or parts to ensure that paths and interactions amongst multiple robots or machines involved may be optimized and collision free. As will be described in more detail below, the kinetic simulation may enable the dismantling workflow to provide detailed instructions to the robotic systems and/or dismantling systems within the ideal dismantling workflow. The dismantling workflow module 150 may support a plurality of robotic controllers enabling the export of programs to automated machines within the robotic system, including, but not limited to including, RAPID, Inform, Python® (Python® and all Python-based trademarks are trademarks or registered trademarks of The Python Software Foundation (PSF) in the United States, and/or other countries), Java® (Java and all Java-based trademarks and logos are trademarks or registered trademarks of Oracle America, Inc. and/or its affiliates, in the United States and/or other countries) amongst other programming languages for controlling industrial robots. The dismantling workflow module 150 may also utilize one or more machine learning algorithms, such as, but not limited to, decision trees and/or random forests, to build upon the baseline machine learning model (e.g., baseline model) which may be utilized to predict a reusability of different regions or mesh pieces of the 3D model. In this embodiment, the dismantling workflow module 150 may prioritize various features, such as, but not limited to, thickness, cut quality, subsequent handling involved, and associated robotic capabilities. The dismantling workflow module 150 may refine the baseline model to optimize one or more features within the process, such as, but not limited to, cutting angles and/or speed, which may increase the reusability of the structure and cut outcomes over previous dismantling outcomes.

As described above, initially, the dismantling workflow module may utilize the simulation data generated as a result of the plurality of trial-and-error simulations to create the baseline machine learning model (e.g., baseline model). The dismantling workflow module 150 may utilize the baseline model to enhance a performance of strategic functions of one or more machines within the robotic system involved in the dismantling process. For example, if a robot's gripping mechanism is designed for flat surfaces, the baseline model ensures contour paths of the closed-loop 3D contours accommodates this requirement allowing for secure grip points to be created. Additionally, the baseline model may optimize cutting paths to reduce time while ensuring contours are accessible for the robot's capabilities, reducing waste, and ensuring structural integrity of both removed portions and the remaining portions of the structure. Furthermore, the cutting sequence may be iteratively refined based on the structural integrity simulations to ensure the removal of any portion does not compromise overall stability of the structure.

As the dismantling workflow module 150 conducts more simulations and/or monitors the results of implemented ideal dismantling workflows, additional simulation data and actual result data with respect to outcomes is gathered, including, but not limited to, precision of cuts, ease of removal, and integrity of the structure and removed portions throughout the dismantling process. As will be explained in greater detail at step 212, this data may be collected through the one or more IoT devices, cameras, and/or scanners described at step 202 and/or manual input received from the user within the dismantling workflow user interface. This data will be used as feedback for the baseline model to highlight the discrepancies between predicted and actual outcomes. As will be explained in greater detail at step 212, the dismantling workflow module 150 may utilize this data in iteratively adjusting the baseline model based on this feedback loop. For example, if a contour consistently results in suboptimal cuts or structural compromises, the dismantling workflow module 150 will adapt the baseline model to modify that contour in future simulations. The dismantling workflow module 150 may employ a plurality of machine learning methods in optimizing and refining the baseline model, such as, but not limited to, reinforcement learning, which may be utilized to maximize a reward, for example, based on a stability of a cut piece or portion and/or an overall efficiency of a cutting/dismantling operation. Additionally, weights may be utilized if certain cut portions shapes are more reusable and are preferable contours. Furthermore, supervised learning may also be employed by the dismantling workflow module 150, the supervised learning may be utilized to compare the planned cut path and grip points of the plurality of workflows corresponding to the plurality of trial-and-error simulations against successful executions to refine predictions, recommended workflows, rankings of the workflows, amongst other refinements over time to enhance both the baseline model and the accuracy of the trial-and-error simulations.

As will be described in greater detail below at step 208, the ideal dismantling workflow may include at least a closed-loop 3D contour, instructions for each of the machines comprising the robotic system, and instructions for the dismantling system. The closed-loop 3D contour, instructions for each of the machines comprising the robotic system, and the instructions for the dismantling system are derived from the plurality of simulations described above. The dismantling workflow module 150 may consider the robotic capabilities, such as maximum payload and the maximum geometry of the cut portion to be carried out by the robotic system and dismantling system, and based on the trial-and-error simulation, the dismantling workflow module will create different types of closed-loop 3D contours on the structure by utilizing the 3D mesh model of the structure while considering the defined boundary conditions. For example, once the structure is identified at step 202 the dismantling workflow module 150 may utilize a dismantling system, such as a plasma cutting system, to cut the structure or a sample structure/sample object (e.g., object or structure comprised of similar materials and dimensions to the structure to be dismantled) in five different ways. The dismantling workflow module 150 may utilize these figures in creating the trial-and-error simulations to identify the optimal geometric pieces and sizes based on various dimensions. In this example, the user or client may request material pieces with a thickness less than 30 centimeters (cm) but a length and width of around 100-150 cm. Based on these conditions, the dismantling workflow module 150 may set these parameters and perform the cuts/dismantling trial-and-error simulations. Here, once the dismantling workflow module 150 identifies the optimal outcomes the dismantling workflow module 150 may define the closed-loop 3D contours. Once the closed-loop 3D contour is defined, the dismantling workflow module 150 may determine a starting point, for example in the center of the structure to be dismantled, the point cloud of the 3D model is then utilized to define the x, y, and z axes of the structure such that the dismantling process may be executed according to the closed-loop 3D contours while continuously evaluating the structural stability of the structure throughout the efficient dismantling of the structure. While creating the closed-loop 3D contour the dismantling workflow module 150 will continuously evaluate the re-usability and material needs stored in the knowledge corpus (e.g., database 130) such that the closed-loop 3D contour may be corrected or modified.

At 208, the dismantling workflow module 150 determines an ideal dismantling workflow based on the plurality of simulations. The ideal dismantling workflow may include at least a closed-loop 3D contour, instructions for each of the machines comprising the robotic system, and instructions for the dismantling system. As described above, the dismantling workflow module 150 may generate the ideal dismantling workflow from one or the plurality of workflows corresponding to the plurality of trial-and-error simulations, wherein the simulation data produced from the trial-and-error simulations is utilized in creating the baseline machine learning model (e.g., baseline model). The baseline model may be refined, enhanced, or re-trained according to the additional simulations described at step 206 and additional data received from the IoT devices, cameras, scanners, manual input, and/or other means of receiving real-time data described at step 202. The dismantling workflow module 150 may generate the ideal dismantling workflow based on the selection of the user within the dismantling workflow user interface and/or automatically select the ideal dismantling workflow using the trained machine learning model (e.g., refined baseline model, enhanced baseline model).

The ideal dismantling workflow may include at least a closed-loop 3D contour, instructions for each of the machines comprising the robotic system, and instructions for the dismantling system. The closed-loop 3D contour may be an earmarked version of the 3D model of the structure to be dismantled, described in detail at steps 202 and 204. The ideal dismantling workflow may include a closed-loop 3D contour on the structure earmarked for dismantling. The ideal dismantling workflow ensures that the one or more machines of the robotic system may accurately grip specific portions of the structure, and the dismantling system may move along the generated closed-loop 3D contour. For example, a plasma cutting system may move along the generated closed-loop 3D contour precisely cutting the designated portions from the structure. In another example, in which the dismantling system to be utilized requires human operation and/or is unautomated the closed-loop 3D contour may be displayed to the user within the dismantling workflow user interface. The dismantling workflow interface may be integrated with a virtual reality (VR) system, such that the human operators may utilize VR devices such as a VR headset to view the 3D model of the structure, VR herein may include augmented reality (AR) functionality wherein virtual representations, such as, but not limited to, dismantling instructions and/or the closed-loop 3D contour, may be rendered to the user/human operator while interacting with the live environment. In this embodiment, the dismantling workflow module 150 may utilize the one or more VR devices to project the closed-loop 3D contour onto the structure to be dismantled and use visual indicators, such as colors, lines, as well as textual instructions to assist the user in dismantling the structure according to the optimal cut portions of the ideal dismantling workflow.

The instructions for each of the machines or equipment comprising the robotic system and the dismantling system may be based on the plurality of simulations performed at step 206 which utilized digital twin representations of the machines or equipment comprising the robotic system and the dismantling system in performing trial-and-error simulations dismantling the structure according to the real word capabilities and capacities of the machines or equipment comprising the robotic system and the dismantling system.

At 210, the dismantling workflow module 150 transmits the ideal dismantling workflow for the structure. The dismantling workflow module 150 may transmit the ideal dismantling workflow for the structure to at least the robotic system and dismantling system. In embodiments in which at least one or more of the plurality of machines and/or equipment comprising the robotic system and/or the dismantling system are unautomated and/or human operated the dismantling workflow module 150 may additionally transmit the ideal dismantling workflow to a user/human operator.

The instructions for the robotic system and the dismantling system may include exportable program instructions corresponding to the robotic controllers of the machines and/or equipment comprising the robotic and/or dismantling system, such as, but not limited to, the controllers and programs described in detail at step 206. Additionally, in embodiments in which at least one or more of the plurality of machines and/or equipment comprising the robotic system and/or the dismantling system are unautomated and/or human operated the dismantling workflow module 150 may utilize at least on screen instructions and/or AR/VR in transmitting the ideal dismantling workflow to the human operator. The instructions may also include arrangement of removed portions, such as stacking and organization, as well as ideal storage areas and transportation.

In embodiments in which the robotic and dismantling systems are fully automated, the dismantling system may cut the structure to be dismantled according to the sequenced optimal cut portions comprising the closed-loop 3D contour. As will be explained in more detail below at step 212, the dismantling workflow module 150 may ensure the dismantling system is capable of following the contour and adjustable/responsive to the robotic systems movement. The dismantling workflow module 150 may utilize the digital twin simulation model and real time data from the robotic systems and dismantling systems to continuously evaluate capabilities and stabilities such that real-time adjustments may be made by updating the instructions. For example, updating the instructions to one of the machines of the robotic system to change the gripping area based on an updated identified center of gravity of the structure during the dismantling process.

At 212, the dismantling workflow module 150 may monitor the implementation of the ideal dismantling workflow of the structure. The dismantling workflow module 150 may monitor the implementation of the ideal dismantling workflow in real time utilizing the images, scans, and data received from the one or more IoT devices described at step 202 as well as manual input or feedback received from the user within the dismantling workflow user interface. As described in detail above, depending on the level of automation of the robotic systems and dismantling systems the dismantling process may be implemented in the real world with or without human involvement.

The dismantling workflow module 150 may utilize the data received in updating the plurality of digital twins corresponding to the machines and equipment comprising the robotic systems and dismantling systems, as well as the 3D model of the structure being dismantled. The updated digital twins of the robotic and dismantling systems may reflect the real time capabilities of the machines and/or equipment such that the dismantling workflow module 150 may adjust the ideal dismantling workflow to reflect the capabilities and/or conditions within the industrial environment. Furthermore, the data may be utilized to monitor the structural stability of the structure by updating the 3D model throughout the dismantling process. For example, the dismantling workflow module may continuously perform simulations, such as, the structural integrity simulations, in monitor the structural stability of the structure to ensure safety. The dismantling workflow module 150 may halt the dismantling process according to results identified within the structural stability simulations and notify the user accordingly within the dismantling workflow user interface.

The dismantling workflow module 150 may also utilize the data received in refining and enhancing the baseline model such that the plurality of simulation results for future simulations may be improved according to the actual results. The dismantling workflow module 150 may refine and/or enhance the baseline model described in detail at step 206 through active learning which may iteratively adjust the underlying algorithms based on the feedback loop created as additional real-time data is gathered. Additionally, the dismantling workflow module 150 may employ the reinforcement learning methods, supervised learning methods, amongst other machine learning methods described in detail at step 206 in retraining, refining, and enhancing the baseline model. Furthermore, the dismantling workflow module 150 may receive feedback from both the user and clients with respect to the specifications of the materials produced during the dismantling process which may be utilized in further training, refining, and enhancing the underlying machine learning model (e.g., baseline model).

The dismantling workflow module 150 may also adjust the ideal dismantling workflow based on updates in materials and/or metals pricing, additional material requests or orders received within the dismantling workflow user interface, the reusability use-cases both internally and externally, as well as adjustments to maximize the reusability of cut portions over time.

The dismantling workflow module 150 may not only monitor the dismantling process but also the storage, organization, and transportation of the material requests. The dismantling workflow module 150 may be enabled to control an environment in which the material pieces are stored directly using IoT devices associated with storage and/or transportation, including, but not limited to, thermometers, humidity sensors, amongst other sensors. For example, if the dismantling workflow module 150 receives images of a material being stored prior to transport in which the materials appear to be forming rust the dismantling workflow module 150 may directly adapt the environment and/or notify the user. The dismantling workflow module 150 may utilize an image database maintained in the knowledge corpus (e.g., database 130) and one or more classification models in identifying the rust and/or other complications.

The dismantling workflow module 150 may additionally be able to monitor efficiency metrics, such as, percentages of structures repurposed, material waste, orders filled, amongst other efficiency metrics. The dismantling workflow module 150 may monitor these metrics over time and generate visual displays for the user within the user interface such that improvements and efficiencies may be monitored by the user. The dismantling workflow module 150 may also automatically update the list of outstanding material requests as the dismantling workflow module 150 fulfills the order requests such that the user may monitor orders/requests which have not been filled, are in progress, etc.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for implementing an ideal dismantling workflow, the method comprising:
generating a model of a structure to be dismantled;
analyzing capabilities of a plurality of machines comprising a robotic system and a dismantling system, wherein the plurality of machines are designated by a user within a user interface for dismantling the structure;
performing a plurality of simulations using the model of the structure to be dismantled and a plurality of digital twins corresponding to each machine within the robotic system and the dismantling system; and
generating an ideal dismantling workflow, wherein the ideal dismantling workflow includes at least a closed-loop three-dimensional (3D) contour and instructions for each machine within the robotic system and the dismantling system to be utilized in the dismantling of the structure.

2. The method of claim 1, wherein the plurality of simulations include trial-and-error simulations utilized in which simulation data is utilized in training a baseline machine learning model.

3. The method of claim 2, further comprising:
monitoring an implementation of the ideal dismantling workflow, wherein additional data is received from one or more Internet of Things (IoT) devices; and
retraining the baseline machine learning model based on the additional data received using one or more reinforcement learning methods.

4. The method of claim 1, wherein the model of the structure to be dismantled is a three-dimensional (3D) mesh model, and wherein the dismantling system includes a plasma cutting machine.

5. The method of claim 1, wherein the plurality of simulations include structural integrity simulations which are utilized in identifying a proper sequence of cuts within the closed-loop 3D contour.

6. The method of claim 1, wherein the ideal dismantling workflow corresponds to one or more material requests maintained in a knowledge corpus, wherein the one or more material requests are prioritized based on preferences of the user.

7. The method of claim 1, wherein the ideal dismantling workflow includes storage and transportation of dismantled portions of the structure, wherein the storage and the transportation of the dismantled portions are monitored utilizing data received from one or more Internet of Things (IoT) devices.

8. A computer system for implementing an ideal dismantling workflow, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating a model of a structure to be dismantled;
analyzing capabilities of a plurality of machines comprising a robotic system and a dismantling system, wherein the plurality of machines are designated by a user within a user interface for dismantling the structure;
performing a plurality of simulations using the model of the structure to be dismantled and a plurality of digital twins corresponding to each machine within the robotic system and the dismantling system; and
generating an ideal dismantling workflow, wherein the ideal dismantling workflow includes at least a closed-loop three-dimensional (3D) contour and instructions for each machine within the robotic system and the dismantling system to be utilized in the dismantling of the structure.

9. The computer system of claim 8, wherein the plurality of simulations include trial-and-error simulations utilized in which simulation data is utilized in training a baseline machine learning model.

10. The computer system of claim 9, further comprising:
program instructions, stored on at least one of the one or more computer-readable storage media for execution by at least one of the one or more processors via at least one of the one or more memories, to monitor an implementation of the ideal dismantling workflow, wherein additional data is received from one or more Internet of Things (IoT) devices; and
program instructions, stored on at least one of the one or more computer-readable storage media for execution by at least one of the one or more processors via at least one of the one or more memories, to retrain the baseline machine learning model based on the additional data received using one or more reinforcement learning methods.

11. The computer system of claim 8, wherein the model of the structure to be dismantled is a three-dimensional (3D) mesh model, and wherein the dismantling system includes a plasma cutting machine.

12. The computer system of claim 8, wherein the plurality of simulations include structural integrity simulations which are utilized in identifying a proper sequence of cuts within the closed-loop 3D contour.

13. The computer system of claim 8, wherein the ideal dismantling workflow corresponds to one or more material requests maintained in a knowledge corpus, wherein the one or more material requests are prioritized based on preferences of the user.

14. The computer system of claim 8, wherein the ideal dismantling workflow includes storage and transportation of dismantled portions of the structure, wherein the storage and the transportation of the dismantled portions are monitored utilizing data received from one or more Internet of Things (IoT) devices.

15. A computer program product for implementing an ideal dismantling workflow, comprising:
one or more computer readable storage media, and program instructions collectively stored on the one or more computer readable storage media, the program instructions comprising:
generating a model of a structure to be dismantled;
analyzing capabilities of a plurality of machines comprising a robotic system and a dismantling system, wherein the plurality of machines are designated by a user within a user interface for dismantling the structure;
performing a plurality of simulations using the model of the structure to be dismantled and a plurality of digital twins corresponding to each machine within the robotic system and the dismantling system; and
generating an ideal dismantling workflow, wherein the ideal dismantling workflow includes at least a closed-loop three-dimensional (3D) contour and instructions for each machine within the robotic system and the dismantling system to be utilized in the dismantling of the structure.

16. The computer program product of claim 15, wherein the plurality of simulations include trial-and-error simulations utilized in which simulation data is utilized in training a baseline machine learning model.

17. The computer program product of claim 16, further comprising:
program instructions, stored on at least one of the one or more computer-readable storage media, to monitor an implementation of the ideal dismantling workflow, wherein additional data is received from one or more Internet of Things (IoT) devices; and
program instructions, stored on at least one of the one or more computer-readable storage media, to retrain the baseline machine learning model based on the additional data received using one or more reinforcement learning methods.

18. The computer program product of claim 15, wherein the model of the structure to be dismantled is a three-dimensional (3D) mesh model, and wherein the dismantling system includes a plasma cutting machine.

19. The computer program product of claim 15, wherein the plurality of simulations include structural integrity simulations which are utilized in identifying a proper sequence of cuts within the closed-loop 3D contour.

20. The computer program product of claim 15, wherein the ideal dismantling workflow corresponds to one or more material requests maintained in a knowledge corpus, wherein the one or more material requests are prioritized based on preferences of the user.
